(19) United States
(12) Patent Application Publication
(10) Pub. No.: US 2024/0320442 A1
(43) Pub. Date: Sep. 26, 2024

(54) SYSTEM AND METHOD FOR A CREDIBLE INFORMATION GUIDE

(71) Applicant: TOYOTA RESEARCH INSTITUTE, INC., Los Altos, CA (US)

(72) Inventors: Alexandre Leo Stephen FILIPOWICZ, Mountain View, CA (US); Francine R . CHEN, Menlo Park, CA (US); Totte Harri HARINEN, Sunnyvale, CA (US); Kenton Michael LYONS, Los Altos, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/126,242

(22) Filed: Mar. 24, 2023

(51) Int. Cl. G06F 40/40; G06F 16/954; G06V 30/19

(52) U.S. Cl. CPC G06F 40/40; G06F 16/954; G06V 30/19093

(57) ABSTRACT

A method for a credible information guide is described. The method includes identifying a source of content accessed by a user as a non-credible information source if a credibility score is less than a credibility threshold. The method also includes determining a similarity of a message between content of the non-credible information source and a credible content from one or more credible information sources. The method further includes recommending a selected information source to the user, having a credibility score between the non-credible information source and the one or more credible information sources when a lack of message similarity is determined. The method also includes continuing the recommending of selected information sources having gradually increasing credibility scores until a credible source accessed by the user.

### BACKGROUND

### Field

Certain aspects of the present disclosure generally relate to machine assisted cognition and, more particularly, to a system and method for a credible information guide.

### Background

The dissemination of news and information is complicated by the influence of misinformation. Misinformation refers to news or information that is factually incorrect (e.g., “vaccines cause autism”). This type of information is primarily generated by a relatively small number of sources that are not well connected to more established sources. Despite originating from non-credible sources, misinformation propagates quickly and contributes to polarization between people that believe the information and those that do not. A major problem that arises from misinformation is the formation of “echo chambers,” in which individuals seek information that aligns with their beliefs, while ignoring information that runs counter to their beliefs. This echo chamber behavior is reinforced by traditional machine learning recommendation algorithms, which generally end up recommending content related to articles or sources a person has viewed, while ignoring the source's credibility.

A news and information recommendation algorithm that mitigates the influence of misinformation by assessing the credibility of an information source and providing recommendations for alternatives to help steer people towards more credible sources, is desired.

### SUMMARY

A method for a credible information guide is described. The method includes identifying a source of content accessed by a user as a non-credible information source if a credibility score is less than a credibility threshold. The method also includes determining a similarity of a message between content of the non-credible information source and a credible content from one or more credible information sources. The method further includes recommending a selected information source to the user, having a credibility score between the non-credible information source and the one or more credible information sources when a lack of message similarity is determined. The method also includes continuing the recommending of selected information sources having gradually increasing credibility scores until a credible source accessed by the user.

A non-transitory computer-readable medium having program code recorded thereon for a credible information guide is described. The program code is executed by a processor. The non-transitory computer-readable medium includes program code to identify a source of content accessed by a user as a non-credible information source if a credibility score is less than a credibility threshold. The non-transitory computer-readable medium also includes program code to determine a similarity of a message between content of the non-credible information source and a credible content from one or more credible information sources. The non-transitory computer-readable medium further includes program code to recommend a selected information source to the user, having a credibility score between the non-credible information source and the one or more credible information sources when a lack of message similarity is determined. The non-transitory computer-readable medium also includes program code to continue the recommending of selected information sources having gradually increasing credibility scores until a credible source accessed by the user.

A system for a credible information guide is described. The system includes a non-credible source detection module to identify a source of content accessed by a user as a non-credible information source if a credibility score is less than a credibility threshold. The system also includes a content similarity module to determine a similarity of a message between content of the non-credible information source and a credible content from one or more credible information sources. The system further includes a credible source suggestion module to recommend a selected information source to the user, having a credibility score between the non-credible information source and the one or more credible information sources when a lack of message similarity is determined. The system also includes a credible source adaption module to continue the recommending of selected information sources having gradually increasing credibility scores until a credible source accessed by the user.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) of a credible information guide system, in accordance with aspects of the present disclosure.

FIG. 2 is a block diagram illustrating an exemplary software architecture that may modularize artificial intelligence (AI) functions for a credible information guide system, according to aspects of the present disclosure.

FIG. 3 is a diagram illustrating a hardware implementation for a credible information guide system, according to aspects of the present disclosure.

FIG. 4 is a flowchart illustrating a method for a credible information guide, according to aspects of the present disclosure.

FIGS. 5A and 5B are diagrams illustrating connected credibility graphs, according to aspects of the present disclosure.

FIG. 6 is a diagram illustrating an X-Y credibility graph according to aspects of the present disclosure.

FIG. 7 is a process flow diagram illustrating a method for a credible information guide, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

The dissemination of news and information is complicated by the influence of misinformation. Misinformation refers to news or information that is factually incorrect (e.g., “vaccines cause autism”). This type of information is primarily generated by a relatively small number of sources that are not well connected to more established sources. Despite originating from non-credible sources, misinformation propagates quickly and contributes to polarization between people that believe the information and those that do not.

A major problem that arises from misinformation is the formation of “echo chambers,” in which individuals seek information that aligns with their beliefs, while ignoring information that runs counter to their beliefs. This echo chamber behavior is reinforced by traditional machine learning recommendation algorithms, which generally end up recommending content related to articles or sources a person has viewed, while ignoring the source's credibility. A news and information recommendation algorithm that mitigates the influence of misinformation by assessing the credibility of an information source and providing recommendations for alternatives to help steer people towards more credible sources, is desired.

Some aspects of the present disclosure are directed to a news and information recommendation algorithm that mitigates the influence of misinformation. In some aspects of the present disclosure, an algorithm assesses the credibility of an information source and provides recommendations for alternatives to help steer individuals towards more credible sources. In some aspects of the present disclosure, the method includes (1) assessing the credibility of a source of information, (2) finding a more credible source and assess consistency between the source's message and messages from more credible sources, if the original source is not credible, (3) finding a source with credibility in between the source and the more credible source, if the source is not credible and its messaging is inconsistent with credible sources, and (4) continuing recommending “in-between” sources until the person starts consulting more credible sources.

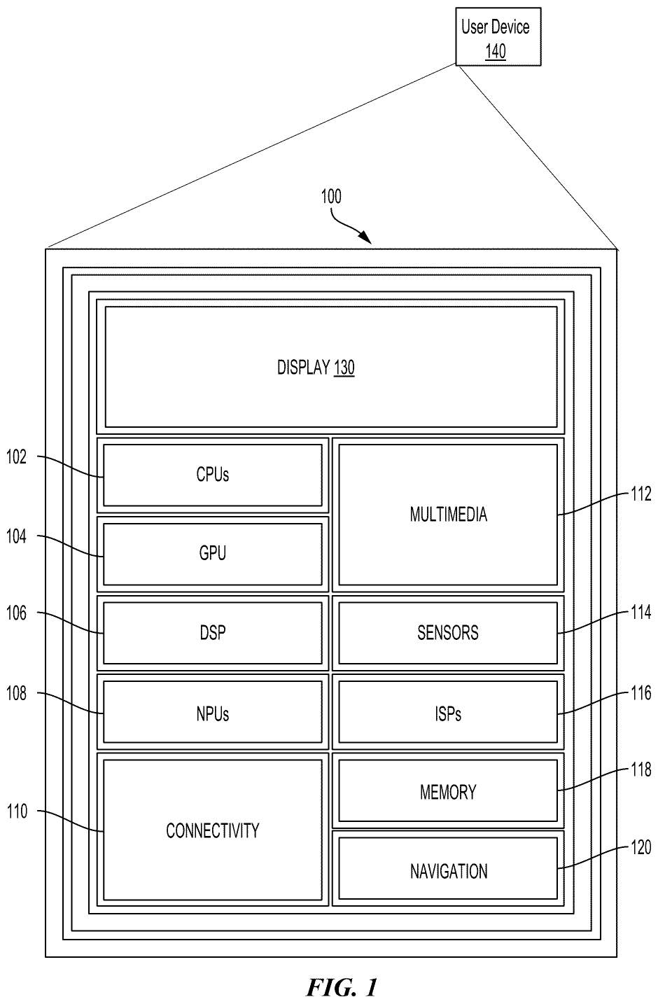

FIG. 1 illustrates an example implementation of the aforementioned system and method for a credible information guide system using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, select a control action, according to the display 130 illustrating a view of a user device.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risk Machine (ARM) instruction set or the like. In another aspect of the present disclosure, the SOC 100 may be a server computer in communication with a user device 140. In this arrangement, the user device 140 may include a processor and other features of the SOC 100.

In this aspect of the present disclosure, instructions loaded into a processor (e.g., CPU 102) or the NPU 108 may include code to provide a credible information guide for reducing user exposure to misinformation. The instructions loaded into a processor (e.g., CPU 102) may also include code to identify a source of content accessed by a user as a non-credible source if a credibility score of the source is less than a predetermined threshold. The instructions loaded into the processor (e.g., CPU 102) may also include code to determine a similarity between the content of the non-credible source and credible content from at least one credible source. The instructions loaded into the processor (e.g., CPU 102) may also include code to recommend a selected source to the user, having a credibility score between the non-credible source and the at least one credible source when a lack of similarity is determined. The instructions loaded into the processor (e.g., CPU 102) may also include code to continue to recommend selected sources having gradually increasing credibility scores until the user accesses a credible source.

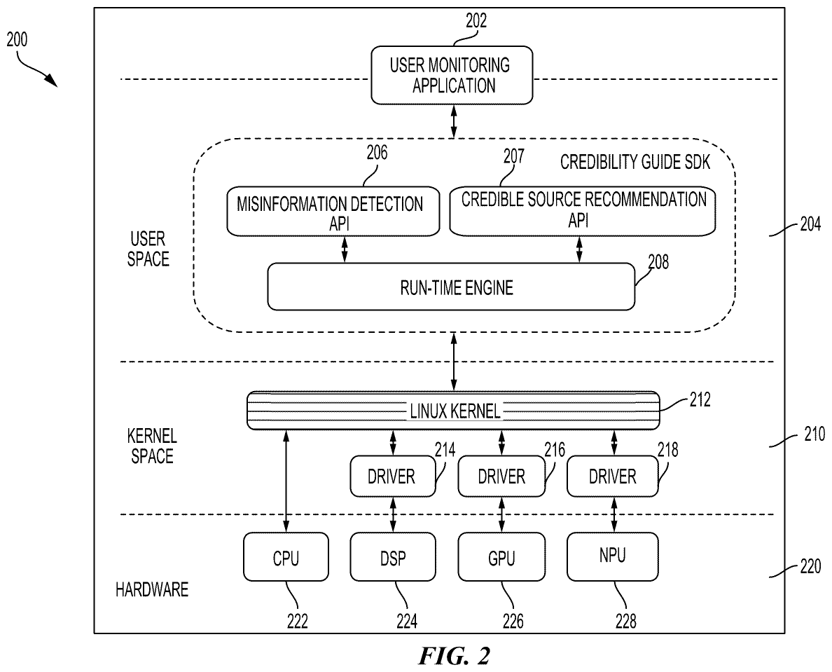

FIG. 2 is a block diagram illustrating a software architecture 200 that may modularize artificial intelligence (AI) functions for a credible information guide system, according to aspects of the present disclosure. Using the architecture, a user monitoring application 202 may be designed such that it may cause various processing blocks of an SOC 220 (for example a CPU 222, a DSP 224, a GPU 226, and/or an NPU 228) to perform supporting computations during run-time operation of the user monitoring application 202. FIG. 2 describes the software architecture 200 for a credible information guide. It should be recognized that the credible information guide system is not limited to any specific information. According to aspects of the present disclosure, the user monitoring and the credible information guide functionality is applicable to any type of information access activity.

The user monitoring application 202 may be configured to call functions defined in a user space 204 that may, for example, provide credible information guide services. The user monitoring application 202 may make a request for compiled program code associated with a library defined in a misinformation detection application programming interface (API) 206. The misinformation detection API 206 is configured to identify a source of content accessed by a user as a non-credible source if a credibility score of the source is less than a predetermined threshold. The misinformation detection API 206 is further configured to determine a similarity between the content of the non-credible source and credible content from at least one credible source.

In response, compiled program code of a credible source recommendation API 207 is configured to recommend a selected source to the user, having a credibility score between the non-credible source and the at least one credible source when a lack of similarity is determined. Additionally, the credible source recommendation API 207 is configured to continue to recommend selected sources having gradually increasing credibility scores until the user accesses a credible source. In some aspects of the present disclosure, the credible source recommendation API 207 provides recommendations for alternatives to help steer individuals towards more credible sources.

A run-time engine 208, which may be compiled code of a run-time framework, may be further accessible to the user monitoring application 202. The user monitoring application 202 may cause the run-time engine 208, for example, to take actions for recommendations of alternatives to help steer individuals towards more credible sources. In response to detection of the misinformation, the run-time engine 208 may in turn send a signal to an operating system 210, such as a Linux Kernel 212, running on the SOC 220. FIG. 2 illustrates the Linux Kernel 212 as software architecture for a credible information guide. It should be recognized, however, that aspects of the present disclosure are not limited to this exemplary software architecture. For example, other kernels may provide the software architecture to support the credible information guide functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

The dissemination of news and information is complicated by the influence of misinformation. Misinformation refers to news or information that is factually incorrect. Despite originating from non-credible sources, misinformation propagates quickly and contributes to polarization between people that believe the information and those that do not. Additionally, a major problem that arises from misinformation is the formation of “echo chambers,” in which individuals seek information that aligns with their beliefs, while ignoring information that runs counter to their beliefs. This echo chamber behavior is reinforced by traditional machine learning recommendation algorithms, which generally end up recommending content related to articles or sources a person has viewed, while ignoring the source's credibility.

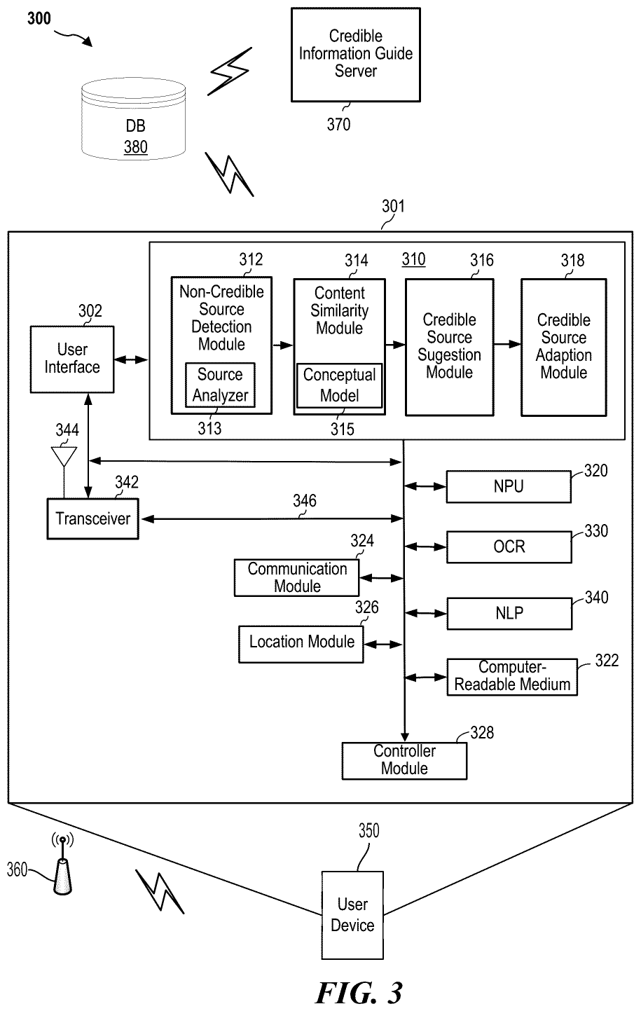

Some aspects of the present disclosure are directed to a news and information recommendation algorithm that mitigates the influence of misinformation. In some aspects of the present disclosure, an algorithm assesses the credibility of an information source and provides recommendations for alternatives to help steer individuals towards more credible sources. In some aspects of the present disclosure, the method includes finding a more credible source and assessing consistency between a non-credible source's message and messages from more credible sources, and finding a source with credibility in between the source and the more credible source, if the source is not credible and its messaging is inconsistent with credible sources, for example, as shown in FIG. 3.

FIG. 3 is a diagram illustrating a hardware implementation for a credible information guide system 300, according to aspects of the present disclosure. The credible information guide system 300 may be configured to provide a credible information guide for reducing user exposure to misinformation. The credible information guide system 300 is configured to identify a source of content accessed by a user as a non-credible source if a credibility score of the source is less than a predetermined threshold. The credible information guide system 300 is also configured to determine a similarity between the content of the non-credible source and credible content from at least one credible source. Additionally, the credible information guide system 300 is configured to recommend a selected source to the user, having a credibility score between the non-credible source and the at least one credible source when a lack of similarity is determined. The credible information guide system 300 is configured to continue to recommend selected sources having gradually increasing credibility scores until the user accesses a credible source.

The credible information guide system 300 includes a user monitoring system 301 and a credible information guide server 370 in this aspect of the present disclosure. The user monitoring system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a Smartbook, an Ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The credible information guide server 370 may connect to the user device 350 for monitoring content accessed by the user to determine whether the content involves misinformation. For example, the credible information guide server 370 may identify a source of content accessed by a user as a non-credible source if a credibility score of the source is less than a predetermined threshold. The credible information guide server 370 may also determine a similarity between the content of the non-credible source and credible content from at least one credible source. Additionally, the credible information guide server 370 may also recommend a selected source to the user, having a credibility score between the non-credible source and the at least one credible source when a lack of similarity is determined. The credible information guide server 370 may continue to recommend selected sources having gradually increasing credibility scores until the user accesses a credible source for reducing user exposure to misinformation.

The user monitoring system 301 may be implemented with an interconnected architecture, represented generally by an interconnect 346, which may be implemented as a controller area network (CAN). The interconnect 346 may include any number of point-to-point interconnects, buses, and/or bridges depending on the specific application of the user monitoring system 301 and the overall design constraints. The interconnect 346 links together various circuits including one or more processors and/or hardware modules, represented by a user interface 302, a user activity module 310, a neural network processor (NPU) 320, a computer-readable medium 322, a communication module 324, a location module 326, a controller module 328, an optical character recognition (OCR) 330, and a natural language processor (NLP) 340. The interconnect 346 may also link various other circuits such as timing sources, peripherals, voltage regulators, and power management circuits, which are well known in the art, and therefore, will not be described any further.

The user monitoring system 301 includes a transceiver 342 coupled to the user interface 302, the user activity module 310, the NPU 320, the computer-readable medium 322, the communication module 324, the location module 326, the controller module 328, the OCR 330, and NLP 340. The transceiver 342 is coupled to an antenna 344. The transceiver 342 communicates with various other devices over a transmission medium. For example, the transceiver 342 may receive commands via transmissions from a user. In this example, the transceiver 342 may receive/transmit information for the user activity module 310 to/from connected devices within the vicinity of the user device 350.

The user monitoring system 301 includes the NPU 320, the OCR 330, and the NLP 340 coupled to the computer-readable medium 322. The NPU 320, the OCR 330, and NLP 340 performs processing, including the execution of software stored on the computer-readable medium 322 to provide a neural network model for user monitoring and statistical data clarification functionality according to the present disclosure. The software, when executed by the NPU 320, the OCR 330 and the NLP 340, causes the user monitoring system 301 to perform the various functions described for presenting analogies to clarify statistical data presented to the user through the user device 350, or any of the modules (e.g., 310, 324, 326, 330, and/or 340). The computer-readable medium 322 may also be used for storing data that is manipulated by the OCR 330 and the NLP 340 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the autonomous vehicle 350 and/or the location module 326 compliant with the following DSRC standards, including any derivative or fork thereof: EN 12253:2004 Dedicated Short-Range Communication-Physical layer using microwave at 5.8 GHz (review); EN 12795:2002 Dedicated Short-Range Communication (DSRC)-DSRC Data link layer: Medium Access and Logical Link Control (review); EN 12834:2002 Dedicated Short-Range Communication-Application layer (review); EN 13372:2004 Dedicated Short-Range Communication (DSRC)-DSRC profiles for RTTT applications (review); and EN ISO 14906:2004 Electronic Fee Collection-Application interface.

The communication module 324 may facilitate communications via the transceiver 342. For example, the communication module 324 may be configured to provide communication capabilities via different wireless protocols, such as 5G new radio (NR), Wi-Fi, long term evolution (LTE), 4G, 3G, etc. The communication module 324 may also communicate with other components of the user device 350 that are not modules of the user monitoring system 301. The transceiver 342 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The user monitoring system 301 also includes the OCR 330 and the NLP 340 to automatically detect accessed control (e.g., news and information sources) to enable detection of misinformation. The user monitoring system 301 may follow a process to detect and determine whether misinformation is accessed by the user. When the user accesses content, the user monitoring system 301 utilizes the OCR 330 and/or the NLP 340 to detect a messaging of a source of the content.

The user activity module 310 may be in communication with the user interface 302, the NPU 320, the computer-readable medium 322, the communication module 324, the location module 326, the controller module 328, the OCR 330, the NLP 340, and the transceiver 342. In one configuration, the user activity module 310 monitors communications from the user interface 302. The user interface 302 may monitor user communications to and from the communication module 324. According to aspects of the present disclosure, the OCR 330 and the NLP 340 automatically detect statistical data and may use computer vision techniques to automatically detect the statistical data.

As shown in FIG. 3, the user activity module 310 includes a non-credible source detection module 312, a content similarity module 314, a credible source suggestion module 316, and a credible source adaption module 318. The non-credible source detection module 312, the content similarity module 314, the credible source suggestion module 316, and the credible source adaption module 318 may be components of a same or different artificial neural network, such as a deep convolutional neural network (CNN). The user activity module 310 is not limited to a CNN. The user activity module 310 monitors and analyzes content accessed by a user from the user interface 302.

This configuration of the user activity module 310 includes the non-credible source detection module 312 configured to identify a source of content accessed by a user as a non-credible source if a credibility score of the source is less than a predetermined threshold. In some aspects of the present disclosure, the non-credible source detection module 312 uses the OCR 330 and the NLP 340 to determine whether content accessed by the user through the user interface 302 is from a non-credible source. In some aspects of the present disclosure, the non-credible source detection module 312 assesses an information source's credibility using graph theory to quantify a number of edges, nodes, and average path lengths that are tied to the source.

In some aspects of the present disclosure, these graph metrics are adapted to a number of platforms where a source fits within a social media network or by measuring a degree to which a website is connected to other websites. For example, these metrics are combined together to form a credibility “score” that is assigned to the source. In some aspects of the present disclosure, the assigned credibility score is relative to a credibility threshold, such that non-credible sources are assigned a credibility score less than the credibility threshold, and credible sources are assigned a credibility score less than the credibility threshold.

In some aspects of the present disclosure, the non-credible source detection module 312 includes a source analyzer model 313 to identify non-credible sources of content viewed by the user. In these aspects of the present disclosure, the source analyzer model 313 uses a tuned natural language processing algorithm (e.g., using the NLP 340) to determine the topic and sentiment of the article and the content accessed by the user. The source analyzer model 313 may be implemented using a tuned natural language processing algorithm, such as a topic modeling approach and/or sentiment analysis. The source analyzer model 313 may also recognize whether a given piece of content is related to other content viewed by the user. In particular, the source analyzer model 313 establishes a frame of reference for analyzing a message of the content provided by a non-credible source to assist with determining whether the message of the non-credible source is consistent with a message of credible sources.

Additionally, the user activity module 310 includes the content similarity module 314 that is configured to determine a similarity between the content of the non-credible source and credible content from at least one credible source. When a non-credible source is detected using the source analyzer model 313, the content similarity module 314 is configured to a search for a more credible source as well as assessing candidate sources for consistency between the candidate source's message and messages from the more credible candidate sources. If an information source has a low credibility score, a conceptual model 315 is configured with natural language processing methods (e.g., latent semantic analysis, probabilistic latent semantic analysis, latent Dirichlet allocation) for identifying a topic of the information source.

In some aspects of the present disclosure, the conceptual model 315 is trained to perform a search for another information source that covers the same topic as the non-credible source but also has a higher credibility score (e.g., sources that have a high degree of connections to broad parts of a graph). Then, the messaging and the consistency in the messaging of the non-credible source and the more credible source is conducted. This step determines how much a source's messaging deviates from more credible sources, with misinformation likely being deemed as less credible and with less messaging consistency with more credible sources.

In these aspects of the present disclosure, the user activity module 310 includes the credible source suggestion module 316 configured to recommend a selected source to the user, having a credibility score between the non-credible source and the at least one credible source when a lack of similarity is determined. In some aspects of the present disclosure, when a non-credible source is detected and messaging of the non-credible source is inconsistent with credible sources, a selected source with credibility in between the non-credible source and the more credible source is identified. In some aspects of the present disclosure, the credible source suggestion module 316 finds and recommends new information sources that are in between the non-credible and more credible information sources, both in terms of their credibility score and in their topic content. This ensures that a new source is recommended that has some overlap in content between the non-credible source and the more established credible sources that, based on behavioral science research, makes a person more likely to engage with its content.

In addition, the user activity module 310 includes the credible source adaption module 318 to continue to recommend selected sources having gradually increasing credibility scores until the user accesses a credible source. In some aspects of the present disclosure, the credible source adaption module 318 is a presentation interface component that displays recommendations of “in-between” sources that are continually provided until the user consults more credible sources. Once the user engages with a new more credible source from the credible source suggestion module 316, the user activity module 310 then anchors itself on this new source and recommends more sources with credibility scores and topic content in between this new source and the previously identified more credible source. This step repeats until the person starts consulting highly credible sources.

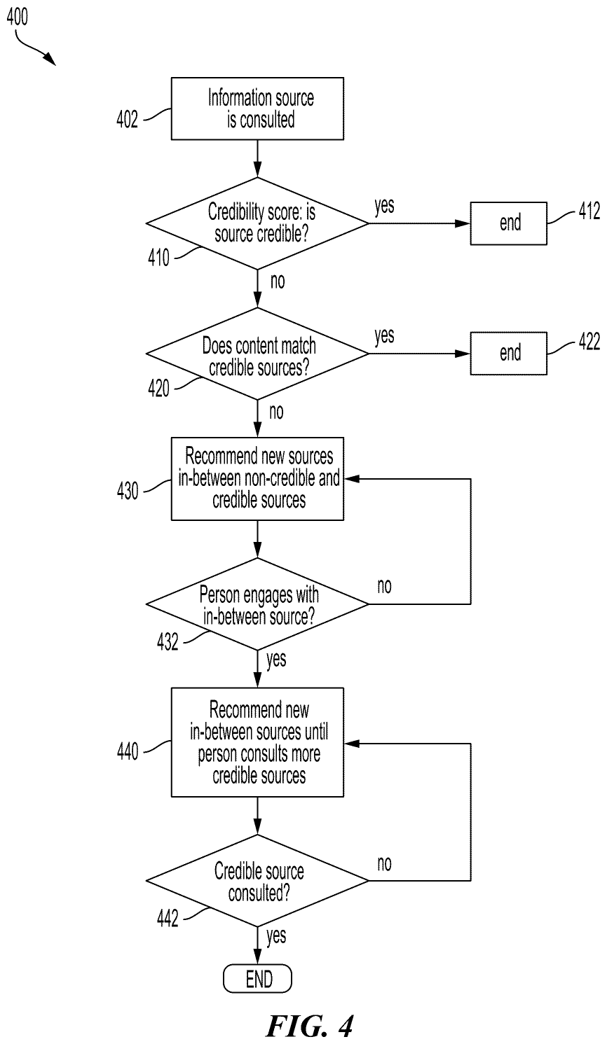

In some aspects of the present disclosure, the user activity module 310 may be implemented and/or work in conjunction with the credible information guide server 370. In one configuration, a database (DB) 380 stores data related to credible sources and previously accessed content messages and the display unit may output, as the user interface 302. In some aspects of the present disclosure, the credible information guide system 300 may include a web browser plugin. In other aspects of the present disclosure, the credible information guide server 370 provides an offline application that scans downloaded articles or documents related to the currently viewed document. In other aspects of the present disclosure, the credible information guide system 300 may include a mobile application that scans content/text displayed on the user interface 302 to determine whether the information source is credible, for example, as shown in FIG. 4.

FIG. 4 is a flowchart illustrating a method for a credible information guide, according to aspects of the present disclosure. A method 400 of FIG. 4 begins at block 402, in which an information source is consulted by a user. For example, as described in FIG. 3, the credible guide information process is applied to content viewed by a user on the user interface 302 to automatically determine whether the source of the content is credible at block 410 in response to detected access at block 402. For example, the content accessed by the user may include misinformation, which refers to news or information that is factually incorrect. This type of information is primarily generated by a relatively small number of sources that are not well connected to more established sources. Despite originating from non-credible sources, protecting the user from accessing misinformation is difficult because misinformation propagates quickly and contributes to polarization between people that believe the information and those that do not.

In particular, misinformation tends to be propagated by few, common actors with little connection to other more established sources (e.g., for COVID, doctors with views that are not well connected to the broader medical community). As such, less credible sources will be connected to a narrower network than more credible, broadly established sources (e.g., for COVID, sole actor vs more established sources such as the CDC). A source's credibility could also be initialized in the system based on some known criteria (e.g., a government source could be initialized as being credible, even if not well connected).

Referring again to FIG. 4, at block 410, a credibility score of the information source is analyzed to determine whether the information source is credible or non-credible. For example, as shown in FIG. 3, the non-credible source detection module 312 assesses an information source's credibility using graph theory to quantify a number of edges, nodes, and average path lengths that are tied to the information source. In some aspects of the present disclosure, these graph metrics are adapted to a number of platforms in which a source fits within a social media network or by measuring a degree to which a source website is connected to other websites. For example, these metrics are combined together to form a credibility “score” that is assigned to the information source.

For example, at block 410, the credibility score of the information source is analyzed to determine whether the source is credible. In some aspects of the present disclosure, the assigned credibility score is relative to a credibility threshold, such that non-credible sources are assigned a credibility score less than the credibility threshold, and credible sources are assigned a credibility score greater than the credibility threshold. For example, when the credibility score is greater than a credibility threshold, the information source is identified as a credible source at block 412, in which the credible guide process of FIG. 4 terminates. Otherwise, control flow branches to block 420.

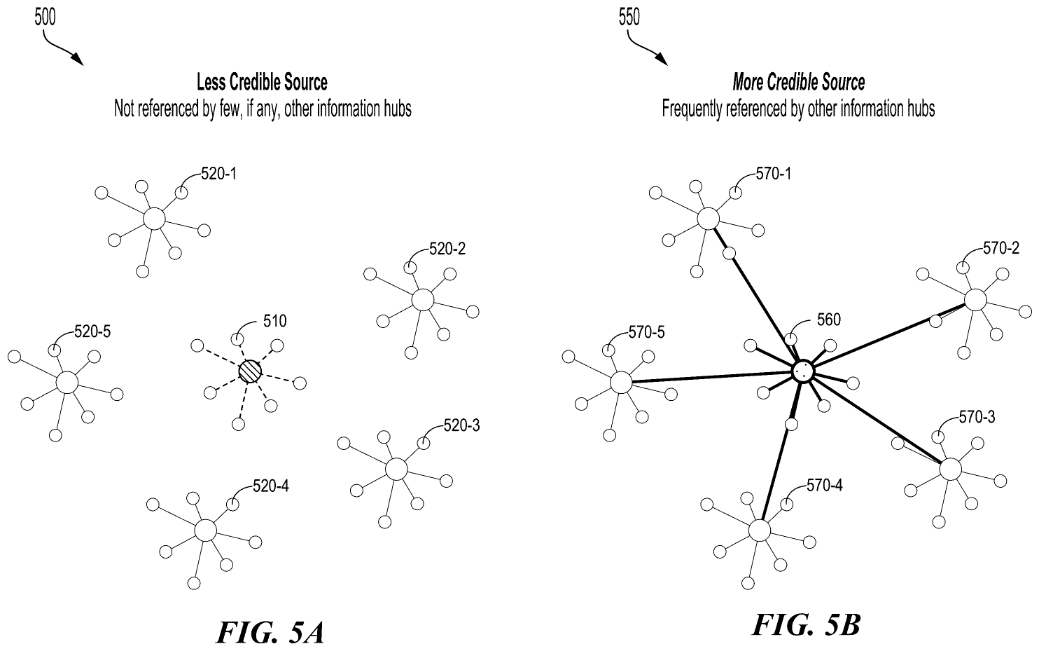

FIGS. 5A and 5B are diagrams illustrating connected credibility graphs, according to aspects of the present disclosure. FIG. 5A illustrates a less credible source graph 500, in which an information source hub 510 is reference by few, if any, other information hubs 520 (520-1, 520-2, 520-3, 520-4, 520-5). By contrast FIG. 5B illustrates a credible source graph 550, in which an information source hub 560 is reference by each of the other information hubs 570 (570-1, 570-2, 570-3, 570-4, 570-5). As shown in FIGS. 5A and 5B, circles indicate information sources and edges indicate the other sources that they are informed by the information source. Additionally, larger circles indicate bigger information source hubs.

In some aspects of the present disclosure, a source's credibility is measured based on how frequently the information source hub is referenced by other information hubs. As shown in FIG. 5A, information source hubs that are not credible are ones that may be connected to smaller hubs (e.g., small blogs), but are not well connected to larger information hubs (e.g., major news outlets; red circle shows a less credible information source). As shown in FIG. 5B, more credible information source hubs are those that are connected to larger information hubs, such as the information source hub 560, which is identified as credible information source).

These graph metrics can be adapted to a number of platforms such where a source fits within a social media network or by measuring how much a website is connected to or referenced by other websites. For example, sources could be deemed more credible if they inform other information hubs for determining a source's “authority,” for example, as shown in FIG. 5B. Conversely, sources could be deemed less credible if the sources they inform are not information hubs, for example, as shown in FIG. 5A. In some aspects of the present disclosure, these metrics are combined together to form a credibility” score” that is assigned to the information source.

Referring again to FIG. 4, at block 420, it is determined whether content of the information source matches content from credible sources. At block 420, when the information source is identified as non-credible, a search for a more credible source is triggered in the form of candidate sources. In this example, the candidate sources are assessed for consistency between the candidate source's message and messages from the more credible candidate sources. When an information source is identified as having a low credibility score, at block 420 natural language processing methods (e.g., latent semantic analysis, probabilistic latent semantic analysis, latent Dirichlet allocation) are used to identify a topic of the non-credible information source.

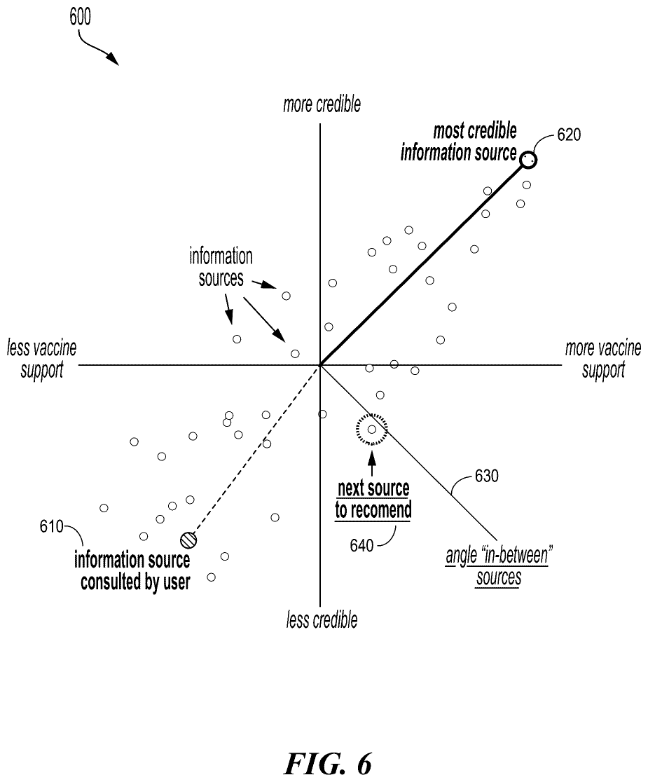

Once the topic is determined, a search for another information source that covers the same topic but also has a higher credibility score is conducted at block 420 (e.g., sources that have a high degree of connections to broad parts of a graph as illustrated in FIG. 5B). Next, the messaging and the consistency in the messaging of the non-credible information source and the more credible source is conducted to determine whether a lack of message similarity is detected. For example, the semantic embeddings are extracted from the text of each source and a cosine angle is measured between embeddings, with smaller cosine angles indicating more consistency between sources and larger angles indicating less consistency (see FIG. 6). In this example, this step determines how much a source's messaging deviates from more credible sources, with misinformation likely being deemed as less credible and with less messaging consistency with more credible sources.

In some aspects of the present disclosure, block 420 determines how much a non-credible source's messaging deviates from more credible sources, with misinformation likely being deemed as less credible and with less messaging consistency with more credible sources. Nevertheless, if message consistency is determined between the non-credible information source and the more credible sources, control flow branches to block 422, in which the credible guide process of FIG. 4 terminates. Otherwise, control flow branches to block 430, in which the credible guide process of FIG. 4 continues and the credible guide process attempts to steer the user to more credible information sources.

At block 430, new information sources having credibility sources between the non-credible sources and credible information sources are presented to the user. In this example, the information source accessed by the user is not credible and the messaging of the information source is inconsistent with credible sources. The identification of the non-credible information source triggers identification of a new information source having a credibility score in between the non-credible information source and more credible information source.

As recognized by some aspects of the present disclosure, behavioral science and research on misinformation show strong “confirmation biases,” such that people ignore credible information if it deviates too far from their current beliefs. Nevertheless, this same research shows that individuals are willing to pay attention to information that deviates a little, but not too much from their current beliefs. In some aspects of the present disclosure, a recommendation algorithm identifies and recommends new information sources that are in-between the non-credible and more credible information sources, both in terms of their credibility score and in their topic content, for example, using a credibility graph as shown in FIG. 6.

FIG. 6 is a diagram illustrating an X-Y credibility graph according to aspects of the present disclosure. The credibility graph 600 of FIG. 6 provides an example process for choosing a next information source to recommend. For example, a y-axis of the credibility graph 600 represents a credibility score assigned to different information sources and the x-axis represents semantic embeddings related to, for example, vaccine support. In this example, a distance between a non-credible information source 610 the user has consulted and a credible information source 620 is measured using cosine angle. Additionally, a vector 630 is drawn halfway in-between the two sources (e.g., 610, 620). A next source to recommend 640 is an information source found closest to the vector 630.

For example, if using cosine angle to measure deviations between the non-credible information source 610 the user is consulting and a more credible information source 620 on the same topic (e.g., support for vaccines), an information source is selected that lies at the midway point of the cosine angle between the two sources (e.g., 610, 620), the next source to recommend 640 is selected for the user. This process ensures that a new source is recommended that has some overlap in content between the non-credible information source 610 and a more established, credible information source 620 that, based on behavioral science research, makes a person more likely to engage with the content.

Referring again to FIG. 4, at block 432, block 430 is repeated until it is determined that the user engaged with a recommended information source. In some aspects of the present disclosure, the credible guide process finds and recommends new information sources, having credibility scores that are in between the non-credible information source and more credible information sources, both in terms of their credibility score and in their topic content. This ensures that a new source is recommended that has some overlap in content between the non-credible information source and more established credible sources that, based on behavioral science research, makes a person more likely to engage with the content of the new information source, as determined at block 432. Once the user engages with the recommended, in-between sources, control flow branches to block 440.

At block 440, new, in-between sources are recommended to the user until the user consults more credible information sources. As shown in block 430, recommendation of new information sources with “in-between” credibility scores are continually provided until the user starts consulting more credible sources. Once a user engages with a new more credible source at block 432, the credible information guide process then anchors itself on this new source and recommends more sources with credibility scores and topic content in between this new information source and the previously identified credible information source. At block 442, block 440 is repeated until the user starts consulting highly credible sources.

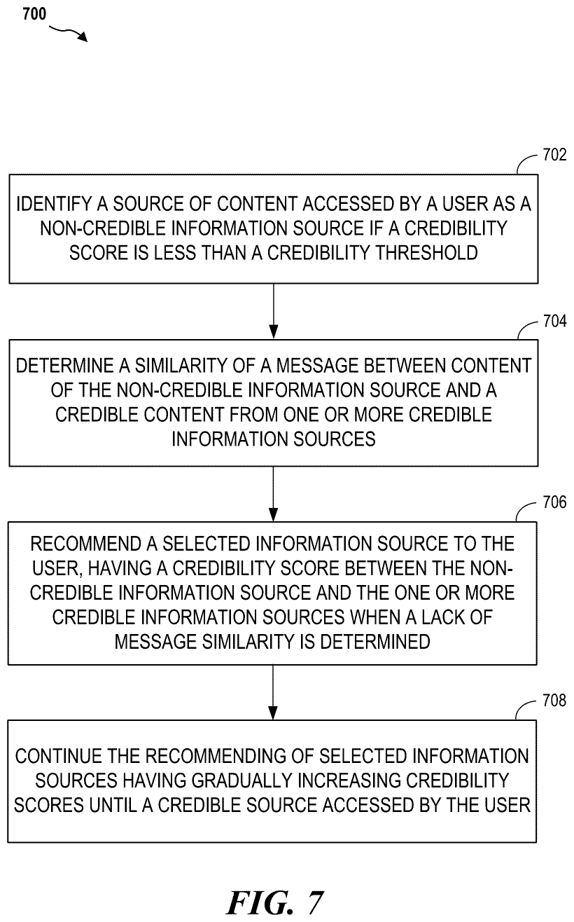

FIG. 7 is a process flow diagram illustrating a method 700 for a credible information guide, according to aspects of the present disclosure. The method 700 begins at block 702, in which a source of content accessed by a user is identified as a non-credible information source if a credibility score is less than a credibility threshold. For example, as shown in FIG. 4, at block 410, a credibility score of the information source is analyzed to determine whether the information source is credible or non-credible. For example, as shown in FIG. 3, the non-credible source detection module 312 assesses an information source's credibility using graph theory to quantify a number of edges, nodes, and average path lengths that are tied to the information source, as shown in FIGS. 5A and 5B. In some aspects of the present disclosure, these graph metrics are adapted to a number of platforms in which a source fits within a social media network or by measuring a degree to which a source website is connected to other websites. For example, these metrics are combined together to form a credibility “score” that is assigned to the information source.

At block 704, a similarity of a message is determined between content of the non-credible information source and a credible content from one or more credible information sources. For example, once a message topic is determined, a search for another information source that covers the same message topic, but also has a higher credibility score, is conducted at block 420 (e.g., sources that have a high degree of connections to broad parts of a graph as illustrated in FIG. 5B). Next, the messaging and the consistency in the messaging of the non-credible information source and the more credible source is conducted to determine whether a lack of message similarity is detected. For example, the semantic embeddings are extracted from the text of each source and a cosine angle is measured between embeddings, with smaller cosine angles indicating more consistency between sources and larger angles indicating less consistency (see FIG. 6). In this example, this step determines how much a source's messaging deviates from more credible sources, with misinformation likely being deemed as less credible and with less messaging consistency with more credible sources.

At block 706, a selected information source is recommended to the user, having a credibility score between the non-credible information source and the one or more credible information sources when a lack of message similarity is determined. At block 708, the recommending of selected information sources having gradually increasing credibility scores is continued until a credible source accessed by the user. For example, as shown in FIG. 4, at block 440, new, in-between sources are recommended to the user until the user consults more credible information sources. As shown in block 430, recommendation of new information sources with “in-between” credibility scores are continually provided until the user starts consulting more credible sources. Once a user engages with a new more credible source at block 432, the credible information guide process then anchors itself on this new source and recommends more sources with credibility scores and topic content in between this new information source and the previously identified credible information source. At block 442, block 440 is repeated until the user starts consulting highly credible sources.

The method 700 may include determining a similarity by identifying a topic of the content accessed by the user from the non-credible information source. Once identified, the method 700 also includes searching for new information sources that cover a topic similar to the identified topic of the non-credible information source. The method 700 further includes selecting one of the new information sources having a credibility score greater than the credibility score of the non-credible information source as the selected information source. Additionally, the method 700 includes identifying the source of content accessed by the user as a credible information source if a topic of the content accessed by the user is consistent with a topic of one or more credible information sources having a higher credibility score. The method 700 may access credibility by generating a graph corresponding to the source of content accessed by the user. Once generated, the method includes quantifying a number of edges, nodes, and average path lengths tied to the source of content accessed by the user to compute the credibility score of the source of content accessed by the user.

The method 700 includes determining the similarity of the message between credible and non-credible sources by measuring a connection between a website of the source of content accessed by the user and a website of the one or more credible sources. Once measure, the method 700 includes identifying one or more platforms in which the source of content accessed by the user fits within a social media network. Next, the method 700 includes combining the measured connection and the one or more platforms within the social media network to form the credibility score assigned to the source of content accessed by the user. The method 700 further includes displaying the recommended information source having a topic content overlapping between the non-credible information source and the one or more credible information sources. When the user engages with a new credible information source, the method 700 further includes recommending information sources with credibility scores and the topic content being in between the new credible information source and the one or more credible information sources until the user consults a credible information source having a predetermined credibility score.

Existing recommender systems (e.g., those that suggest a next video or news article) are optimized for user engagement but largely ignore the credibility of different sources. As a consequence, existing recommender systems can contribute to “echo chambers” by keeping people looped into topics or information sources that users have previously consulted, irrespective of the source's credibility. Some aspects of the present disclosure improve upon existing recommender algorithms by specifically guiding recommendations towards more credible sources. Rather than using the history of participant responses, or adding random “jitter,” some aspects of the present disclosure apply principles from behavioral science to gradually guide individuals away from non-credible sources and towards more reliable sources.

Some aspects of the present disclosure are directed to a news and information recommendation algorithm that mitigates the influence of misinformation. In some aspects of the present disclosure, an algorithm assesses the credibility of an information source and provides recommendations for alternatives to help steer individuals towards more credible sources. In some aspects of the present disclosure, the method includes (1) assessing the credibility of a source of information, (2) finding a more credible source and assess consistency between the source's message and messages from more credible sources, if the original source is not credible, (3) finding a source with credibility in between the source and the more credible source, if the source is not credible and its messaging is inconsistent with credible sources, and (4) continuing recommending “in-between” sources until the person starts consulting more credible sources.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for a credible information guide, comprising:
identifying a source of content accessed by a user as a non-credible information source if a credibility score is less than a credibility threshold;
determining a similarity of a message between content of the non-credible information source and a credible content from one or more credible information sources;
recommending a selected information source to the user, having a credibility score between the non-credible information source and the one or more credible information sources when a lack of message similarity is determined; and
continuing the recommending of selected information sources having gradually increasing credibility scores until a credible source accessed by the user.

2. The method of claim 1, in which identifying comprises:
monitoring the user to determine the content accessed by the user;
determining the source of content accessed by the user; and
computing the credibility score of the source of content accessed by the user.

3. The method of claim 1, in which determining the similarity comprises:
identifying a topic of the content accessed by the user from the non-credible information source;
searching for new information sources that cover a topic similar to the identified topic of the non-credible information source; and
selecting one of the new information sources having a credibility score greater than the credibility score of the non-credible information source as the selected information source.

4. The method of claim 3, in which identifying the topic comprises recognizing the topic of the content accessed by the user using optical character recognition (OCR) and/or natural language processing.

5. The method of claim 1, further comprising identifying the source of content accessed by the user as a credible information source if a topic of the content accessed by the user is consistent with a topic of the one or more credible information sources.

6. The method of claim 1, in which accessing comprises:
generating a graph corresponding to the source of content accessed by the user; and
quantifying a number of edges, nodes, and average path lengths tied to the source of content accessed by the user to compute the credibility score of the source of content accessed by the user.

7. The method of claim 1, in which determining the similarity of the message comprises:
measuring a connection between a website of the source of content accessed by the user and a website of the one or more credible sources;
identifying one or more platforms in which the source of content accessed by the user fits within a social media network; and
combining the measured connection and the one or more platforms within the social media network to form the credibility score assigned to the source of content accessed by the user.

8. The method of claim 1, further comprising:
displaying the recommended information source having a topic content overlapping between the non-credible information source and the one or more credible information sources; and
when the user engages with a new credible information source, recommending information sources with credibility scores and the topic content being in between the new credible information source and the one or more credible information sources until the user consults a credible information source having a predetermined credibility score.

9. A non-transitory computer-readable medium having program code recorded thereon for a credible information guide, the program code being executed by a processor and comprising:
program code to identify a source of content accessed by a user as a non-credible information source if a credibility score is less than a credibility threshold;
program code to determine a similarity of a message between content of the non-credible information source and a credible content from one or more credible information sources;
program code to recommend a selected information source to the user, having a credibility score between the non-credible information source and the one or more credible information sources when a lack of message similarity is determined; and
program code to continue the recommending of selected information sources having gradually increasing credibility scores until a credible source accessed by the user.

10. The non-transitory computer-readable medium of claim 9, in which the program code to identify comprises:
program code to monitor the user to determine the content accessed by the user;
program code to determine the source of content accessed by the user; and
program code to compute the credibility score of the source of content accessed by the user.

11. The non-transitory computer-readable medium of claim 9, in which the program code to determine the similarity comprises:
program code to identify a topic of the content accessed by the user from the non-credible information source;
program code to search for new information sources that cover a topic similar to the identified topic of the non-credible information source; and
program code to select one of the new information sources having a credibility score greater than the credibility score of the non-credible information source as the selected information source.

12. The non-transitory computer-readable medium of claim 11, in which the program code to identify the topic comprises program code to recognize the topic of the content accessed by the user using optical character recognition (OCR) and/or natural language processing.

13. The non-transitory computer-readable medium of claim 9, further comprising program code to identify the source of content accessed by the user as a credible information source if a topic of the content accessed by the user is consistent with a topic of the one or more credible information sources.

14. The non-transitory computer-readable medium of claim 9, in which the program code to access comprises:
program code to generating a graph corresponding to the source of content accessed by the user; and
program code to quantifying a number of edges, nodes, and average path lengths tied to the source of content accessed by the user to compute the credibility score of the source of content accessed by the user.

15. The non-transitory computer-readable medium of claim 9, in which the program code to determine the similarity of the message comprises:
program code to measure a connection between a website of the source of content accessed by the user and a website of the one or more credible sources;
program code to identify one or more platforms in which the source of content accessed by the user fits within a social media network; and
program code to combine the measured connection and the one or more platforms within the social media network to form the credibility score assigned to the source of content accessed by the user.

16. The non-transitory computer-readable medium of claim 9, further comprising:
program code to display the recommended information source having a topic content overlapping between the non-credible information source and the one or more credible information sources; and
when the user engages with a new credible information source, program code to recommend information sources with credibility scores and the topic content being in between the new credible information source and the one or more credible information sources until the user consults a credible information source having a predetermined credibility score.

17. A system for a credible information guide, the system comprising:
a non-credible source detection module to identify a source of content accessed by a user as a non-credible information source if a credibility score is less than a credibility threshold;
a content similarity module to determine a similarity of a message between content of the non-credible information source and a credible content from one or more credible information sources;
a credible source suggestion module to recommend a selected information source to the user, having a credibility score between the non-credible information source and the one or more credible information sources when a lack of message similarity is determined; and
a credible source adaption module to continue the recommending of selected information sources having gradually increasing credibility scores until a credible source accessed by the user.

18. The system of claim 17, in which the non-credible source detection module comprises a source analyzer model trained to monitor the user to determine the content accessed by the user, to determine the source of content accessed by the user; and to compute the credibility score of the source of content accessed by the user.

19. The system claim 17, further comprising a natural language processor (NLP) to recognize a topic of the content accessed by the user.

20. The system claim 17, further comprising a conceptual model trained to identify the source of content accessed by the user as a credible information source if a topic of the content accessed by the user is consistent with a topic of the one or more credible information sources.
